(19) United States
(12) Patent Application Publication
(10) Pub. No.: US 2013/0336504 A1
(43) Pub. Date: Dec. 19, 2013

(54) COMPACT STAND-ALONE STEREO LOUDSPEAKER

(71) Applicant: Jes Mosgaard, Silkeborg (DK)

(72) Inventor: Jes Mosgaard, Silkeborg (DK)

(73) Assignee: LIBRATONE A/S, Skovlunde (DK)

(21) Appl. No.: 13/702,275

(22) PCT Filed: Jun. 7, 2010
(86) PCT No.: PCT/DK2010/050127

§ 371 Date: Jan. 7, 2013

(51) Int. Cl. H04R 5/02

(52) U.S. Cl. CPC H04R 5/02
USPC 381/300

(57) ABSTRACT

Stereo loudspeaker in a single cabinet (CB), such as a portable stereo loudspeaker. Two dipole loudspeaker units (DLL, DLR) generate respective acoustic dipole signals (L+, L−, R+, R−) in accordance with two channels on an input signal. The two dipole loudspeaker units (DLR, DLL) are closesly spaced and oriented such in relation to each other that their respective main axes are angled (α) 70°-110°, such as 80°-100°, preferably substantially 90°, relative to each other. By placing such stereo loudspeaker in a room in front of a wall (W), reflections (RL, RR) from one side of the two dipole units' (DLL, DLR) diaphragms will reach a listener and thus serve to provide, together with the direct sound (L, R) from the opposite side of the diaphragms, a stereo image in a wide area in the room. The dual dipole arrangement enables a one-cabinet stereo loudspeaker with a narrow design. The dipole arrangement may be a two-way system with dipole tweeter units and dipole mid range units. A mono low frequency unit (WF) may be included in the cabinet (CB). The stereo loudspeaker can be configurable to either play stereo or to play mono, i.e. the dipole units (DLL, DLR) playing the same signals. Hereby the loudspeaker can play one channel while a similar loudspeaker plays another channel, thus allowing such set of loudspeakers to be used in a traditional stereo setup.

### FIELD OF THE INVENTION

The invention relates to the field of audio equipment, especially to the field of audio loudspeakers, more specifically the invention provides a one-cabinet stand-alone stereo loudspeaker.

### BACKGROUND OF THE INVENTION

Compact stereo reproducing equipment with a pair of closely spaced stereo loudspeaker units and matching amplifiers in one single cabinet are popular ways of playing stereo sound. Often such systems include docking station capabilities for portable MP3 players and/or CD players.

To enhance the stereo effect, i.e. the impression of a wide sound image, in spite of a small physical distance between loudspeakers, a large variety of signal processing manipulations are known to provide some effects, but either such manipulations tend to decrease other parameters of the overall sound quality, e.g. the timbre, or the effect is only present when the listener is placed between the stereo loudspeaker units.

To provide a stereo effect, the listener must be in the correct position for an acceptable stereo effect, and thus with closesly spaced loudspeakers, this can only be obtained in a limited listening area around the best position, the “sweet spot”. Listening outside such area, the closesly spaced pair of loudspeaker units will be experienced as a mono source and thus not provide the listener with any spacious image.

Furthermore, to provide a certain stereo effect even in the “sweet spot”, the pair of loudspeaker units must be separated by a minimum distance, and thus a minimum width of the cabinet is required to contain such pair of loudspeaker units. Thereby, the acoustical requirements dictate the overall shape of the stereo device, and especially a stereo device with a narrow shape is not possible with traditional acoustical designs.

### SUMMARY OF THE INVENTION

In view of the above, it may be seen as an object of the present invention to provide a compact and portable stereo loudspeaker system which is capable of providing a spacious sound reproduction of a stereo signal in a large area, i.e. also for listening positions outside the area between the stereo loudspeakers.

The invention provides a loudspeaker arranged to receive an input signal with first and second channels and to generate respective first and second acoustic signals accordingly, the loudspeaker having a cabinet comprising

a set of first and second dipole loudspeaker units arranged to generate respective first and second acoustic dipole signals in accordance with the first and second channels,

wherein the first and second dipole loudspeaker units are closesly spaced and oriented such in relation to each other that their respective main axes are angled 70°-110°, such as 80°-100°, preferably around 90°, relative to each other.

Such stereo loudspeaker is advantageous since it provides a spacious stereo reproduction due to the dipole loudspeaker configuration which allows a stereo signal to be radiated both in one direction (front) and in the opposite direction (back). Thus, when the loudspeaker is oriented in a room with its front towards a listening area, the listener will not only experience a stereo sound due to the direct sound from the first and second dipoles, but also the stereo signals from the back of the loudspeaker which arrive to the listener reflected by the walls in the room. Hereby, the listener will experience stereo sound in a large listening area, in principle throughout the listening room.

In addition, the closesly spaced dipole units allow a very narrow cabinet design.

As ‘dipole loudspeaker unit’ a normal standard loudspeaker units such as cone based electro-dynamic loudspeaker can be used, since such units are inherently acoustic dipoles. However, it is to be understood that a dipole can also be implemented as two separate loudspeaker units, e.g. two dome tweeters with flat magnets mounted back to back, since such configuration will, at least up to a certain frequency, act as an acoustic dipole when electrically connected in opposite phase. As dipole loudspeaker unit at high frequencies an air motion transformer unit is preferred.

By ‘closesly spaced’ is understood a distance between the centres of the loudspeaker diaphragms being smaller than two times a maximum extension of their diaphragms, or as close as practically possible. Thus, with such configuration, the loudspeaker can be designed with very compact outer dimensions, and especially with a very narrow cabinet in the extension in which the stereo image is reproduced. This is in contrast to prior art loudspeakers which require a certain physical distance between stereo loudspeaker units in order to be able to reproduce a stereo image and thus such loudspeakers will require a minimum width. In fact it is possible to position the two dipole units so closesly together that the zero points in their dipole radiation patterns coincide, when seen in top view. This means that the two units can in principle be placed right above each other, and thus a cabinet with a width of down to the dimensions of one single loudspeaker unit is possible. It is preferred that the first and second dipole loudspeaker units are spaced with a distance between centres of their diaphragms being smaller than two times a maximum extension of their diaphragms.

The ‘cabinet’ is understood to include at least a structure serving to hold the two loudspeaker units in the desired position relative to each other, thus underlining that one single loudspeaker cabinet includes loudspeaker units capable of reproducing a stereo image, namely the first dipole unit playing left channel and the second dipole unit playing right channel of the input signal. The cabinet is not necessarily a box since in simple embodiments only two dipole loudspeaker units are required to implement the loudspeaker, and these units should be placed such that both sides of their diaphragms look into openings to the environment. For example, the two loudspeaker units may be mounted on two open baffles angled in relation to each other.

Since most normal loudspeaker units are inherently dipoles, the resulting electrical to acoustic efficiency of the loudspeaker will be high because all acoustic energy generated by the dipole units are radiated from the loudspeaker without acoustic energy being wasted in absorbing material.

Preferably, one side of the diaphragms of the first and second dipole loudspeaker units are arranged to generate direct sound to the listener, and the opposite side of the diaphramgs of the first and second dipole loudspeaker units are arranged to generate sound to the listener via reflecting surfaces, such as walls. Thus, it is preferred that the loudspeaker units are mounted in the cabinet such that the diaphragms of the two loudspeaker units are both angled in relation to the front of the cabinet, i.e. the side of the cabinet which is designed to face the listener in a normal listening position. Especially, the two loudseaker units may be symmetrically angled in relation to the front of the cabinet.

Preferably, the first and second dipole loudspeaker units are mounted in the cabinet so as to freely radiate their respective acoustic dipole signals away from the loudspeaker, such as the first and second diople loudspeaker units being mounted to an open part of the cabinet. At least it is preferred, that the two loudspeaker units must be mounted in the cabinet free from acoustical obstacles that will obstruct a significant dipole effect in the horizonal plane, whereas the cabinet may introduce acoustical obstacles in the vertical plane. Especially, the two loudspeaker units may be mounted in through-going openings in respective plane panels or baffles serving to provide the desired angle between the two loudspeaker units, and at the same time serving completely free radiation from both sides of the diaphramgs.

The first and second dipole loudspeaker units may be arranged in the cabinet with their main axes substantially being in a horizontal plane, such as the two unit being placed next to each other. Alternatively, the first and second dipole loudspeaker units may be arranged in the cabinet with their main axes vertically displaced. With the latter configuration, the width of the loudspeaker can be reduced down to the dimensions of one loudspeaker unit, namely if the two loudspeaker units are placed right above each other with their zero points in their dipole radiation pattern coinciding, when seen in top view.

Preferably, the first and second dipole loudspeaker units are oriented such in relation to each other that their respective main axes are substantially perpendicular to each other. This configuration will provide the best separation between left and right stereo channels and thus provide the optimum stereo image.

Preferably, the first and second dipole loudspeaker units are are oriented in the cabinet with fronts of their diaphragms pointing away from a front of the cabinet, such as the fronts of their diaphragms pointing in a direction 120°-150° relative to a front direction. Thus, with such configuration, the fronts of the loudspeaker units face away from the listening position and they are rather facing the wall behind the loudspeaker in an angle of 30°-60°. Alternatively, the first and second dipole loudspeaker units are are oriented in the cabinet with fronts of their diaphragms pointing away from a front of the cabinet, such as the fronts of their diaphragms pointing in a direction 30°-60° relative to a front direction.

In preferred designs, the cabinet has a generally triangular top view with a substantially plane cabinet front. Especially, the outer boundary of the loudspeaker, or at least a significant part of it, may be provided by fabric, whereas hard parts of the cabinet structure suited for mounting of the loudspeaker units is preferably provided by wooden, metallic or polymer panels.

The loudspeaker may comprise a second set of first and second dipole loudspeaker units arranged to generate respective third and fourth signals accordingly, wherein the second set of dipole loudspeaker units are oriented such in relation to each other that their respective main axes are angled 70°-110°, such as 80°-100°, preferably around 90°, relative to each other. With such two-way system, both treble and mid range can be effectively radiated as dipole waves thus providing the described stereo image effect in the most essential part of the audio frequency range. Especially, the loudspeaker may comprise a dividing network, such as a digital dividing network, arranged to split the input signal into a higher frequency band which is applied to the first set of dipole loudspeaker units and into a lower frequency band which is applied to the second set of dipole loudspeaker units. The second set of dipole loudspeaker units may be positioned in substantially the same horizontal plane as the first set of dipole loudspeaker units. Alternatively or additionally, the second set of dipole loudspeaker units may be vertically displaced relative to the first set of dipole loudspeaker units. Especially, in one side a tweeter unit may be placed above a mid range unit, while in the opposite side, the tweeter unit is placed below the mid range unit. The angle between the first and second dipole loudspeaker units may especially be the same for both the first and second set of dipole loudspeaker units, however the angles may be chosen to be at least slightly different.

A preferred embodiment comprises a loudspeaker unit arranged to generate an acoustic signal below a lower cut-off frequency of the input signal, such as a single loudspeaker unit arranged in a lower part of the cabinet below the first and second dipole loudspeaker units, such as said loudspeaker unit being applied with a combined mono signal based on the input signal below the lower cut-off frequency. Such low frequency loudspeaker unit can be placed in a closed or vented part of the cabinet.

In one embodiment the loudspeaker comprises configuration means arranged to apply substantially the same electric signal to both of the first and second dipole loudspeaker units. Such embodiment allows the loudspeaker to function as a mono loudspeaker, thereby allowing the loudspeaker to be used with a second similar loudspeaker also configured as a mono loudspeaker. Hereby, the loudspeaker can be used either as a stereo loudspeaker, as described, or it can be a mono loudspeaker reproducing one stereo channel, if used in a traditional two-loudpeaker stereo setup. The same electric signal applied to both dipole units may be one of the first and second channels of the input signal, e.g. selectable between the first and second channels of the input signal. Preferably, the the configuration means is arranged to switch the loudspeaker configuration between a mono and a stereo setting, such as the configuration means being arranged to switch the loudspeaker configuration between a mono and a stereo setting upon detection of user input, e.g. a switch or jumper setting. Alternatively, the configuration means may be arranged to switch the loudspeaker configuration from a stereo to a mono setting automatically upon detection of the presence of another similar loudspeaker, e.g. using Bluetooth or the like so as to configure one of the loudspeaker to be a master playing one stereo channel, while the other loudspeaker is a slave playing the second stereo channel.

In preferred embodiments, the cabinet comprises a handle arranged for carrying the loudspeaker. This is relevant, since the loudspeaker is suited as a compact portable device, e.g. in a battery driven version.

The loudspeaker is preferably arranged to receive the input signal in a digital format, such as in a wireless digital format. The loudspeaker is preferably suited for streaming of sound from an iPhone, an iPod Touch or the like, and further to receive an input signal from a TV set or a set-top box.

The loudspeaker preferably comprises amplifiers arranged to amplify the input signal and to apply the respective amplified signals to the first and second dipole loudspeaker units, preferably the loudspeaker comprises separate amplifiers to all loudspeaker units included so as to provide a fully active loudspeaker.

In a second aspect, the invention provides a method for playing an input signal with first and second channels, the method comprising

receiving the input signal, and

applying electrical signals corresponding to the first and second channels to respective first and second dipole loudspeaker units arranged to generate respective first and second acoustic dipole signals in accordingly,

wherein the first and second dipole loudspeaker units are mounted closely spaced in a cabinet are oriented such in relation to each other that their respective main axes are angled 70°-110°, such as 80°-100°, preferably around 90°, relative to each other.

It is preferred that the method comprises placing the loudspeaker so as to ensure that one side of the diaphragms of the first and second dipole loudspeaker units point towards the listener position, while the opposite side of the diaphramgs of the first and second dipole loudspeaker units point towards a reflecting surface, such as a walls.

Preferably, the method comprises placing the loudspeaker in a room near a wall behind the loudspeaker so as to ensure that reflections from the wall behind will reach the listener via side walls or other reflecting surfaces in the room.

It is appreciated that equivalent embodiments and advantages mentioned for the first aspect apply as well for the second aspect.

It is appreciated that two or more of the mentioned embodiments can advantageously be combined.

### BRIEF DESCRIPTION OF THE DRAWINGS

Embodiments of the invention will be described, by way of example only, with reference to the drawings, in which

FIG. 1 illustrates a sketch showing a preferred arrangement of the two dipole loudspeaker units and their radiation pattern,

FIG. 2 illustrates a sketch of a loudspeaker embodiment placed in front of a wall with arrows indicating direct sound waves for left and right channel from the loudspeaker as well as sound waves reflected by the wall,

FIG. 3 illustrates for the same loudspeaker embodiment as in FIG. 2 radiation patterns for the loudspeaker placed in a room,

FIG. 4 illustrates a difference in width of stereo image in a room for the loudspeaker of the invention and a traditional stereo loudspeaker setup,

FIG. 5 illustrates three different configurations of sets of tweeters and mid range units, and

FIG. 6 illustrates two views of a preferred compact portable stereo loudspeaker embodiment with two sets of two-way dipole loudspeaker units arranged in an open upper part of the cabinet and with a central woofer unit placed in an enclosure in a lower part of the cabinet.

### DESCRIPTION OF EMBODIMENTS

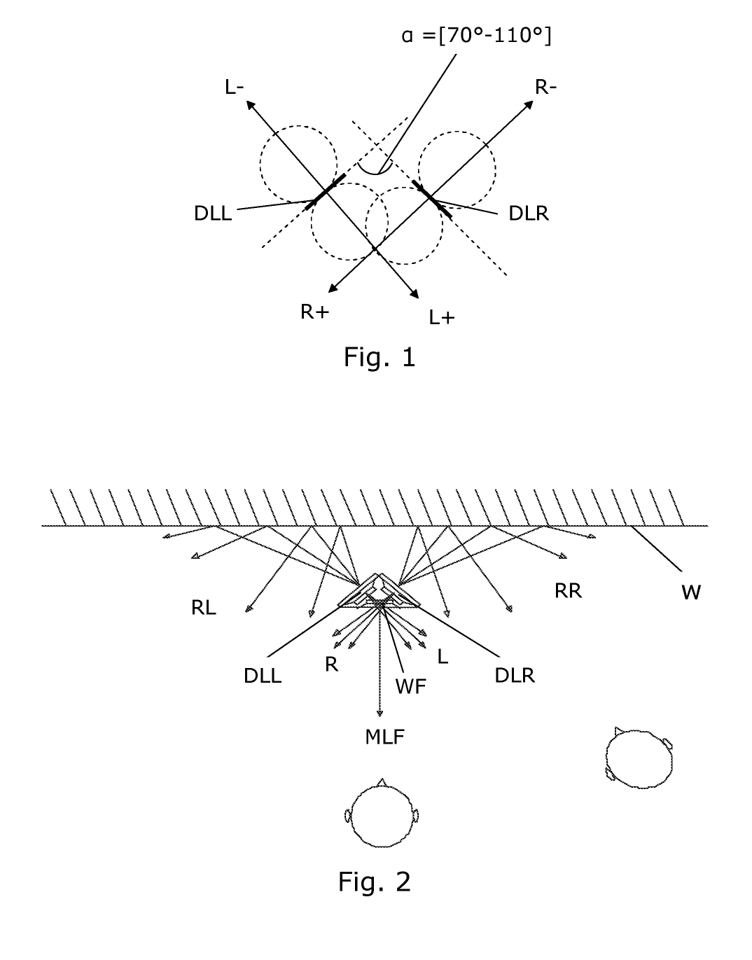

FIG. 1 shows a principle sketch of a simple preferred embodiment seen in top view. The first and second dipole loudspeaker units DLL, DLR are mounted in a cabinet (not illustrated) closely spaced and angled such in relation to each other that the their main axes (indicated by double arrows) provide an angle α with each other being within the range 70°-110°. The main axes of the dipole units DLL, DLR are indicated by the double arrows, and the dipole radiation patterns are indicated with dashed circles. The first dipole unit DLL receives a left channel signal and thus generates a first acoustic dipole signal L+, L− accordingly, while the second dipole unit DLR receives a right channel signal and thus generates a second acoustic dipole signal R+, R− accordingly.

Most preferably, the main axes of the two dipole units DLL, DLR (or their diaphragms, here indicated by bold lines) are substantially perpendicular to each other, i.e. an angle of 90° is preferred. However, it is appreciated that the exact angle α within a 1°-3° is not important from an acoustical point of view. Within the mentioned angle α range 70°-110° a good acoustic effect will be achieved. Preferably, the two units DLL, DLR are placed in the same horizontal plane and arranged so close to each other as practically possible. However, the two units DLL, DLR may also be vertically displaced relative to each other, e.g. placed right on top of each other with their diaphragm centres on the same vertical line.

The effect of the configuration of the two dipole units DLL, DLR is that if DLL is applied with an electric signal representing left channel and DLR is applied with an electric signal representing right channel, then in one direction (upwards on FIG. 1), left L− and right channels R− are radiated to the left and right, respectively, while in the opposite direction (downwards on FIG. 1), left L+ and right R+ channels are reversed. In the following the advantages of such loudspeaker will be described, namely its ability to produce a wide stereo image in a large listening area when reproducing a stereo audio signal in a normal room.

FIG. 2 shows a top view of a loudspeaker embodiment based on the same principle as sketched in FIG. 1, i.e. two dipole loudspeaker units DLL, DLR arranged to reproduce left and right channels of an input signal, respectively. The two units DLL, DLR are arranged in a cabinet angled 90° and with their diaphragm fronts facing away from the listener position. This means that the diaphragm fronts of the two units DLL, DLR provide an angle of 135° with the direction towards the listener position.

A low frequency woofer WF is placed centrally in the cabinet with its diaphragm facing towards the listener position. The woofer WF reproduces a mono signal MLF since is is applied with an electric signal representing a combined version of the two channels in the input signal. In a preferred embodiment, the woofer WF reproduces frequencies below a predetermined split frequency of such as a split frequency of 200-500 Hz.

When the loudspeaker is placed with a certain distance in front of a wall W, it will generate direct sound towards the listener position, namely left L and right R channel signals. Further, the loudspeaker radiates the same signals in opposite phase backwards towards the wall W behind the loudspeaker, and thus resulting reflections RL and RR are genreated. As seen, the listener right in front of the loudspeaker will predominantly receive the direct sound, i.e. L and R directly from the loudspeaker and thus experience a right-left stereo image. The listener sketched to the right side of the loudspeaker predominantly receives the direct sound L from the left unit DLL and reflected sound RR from the right unit DLR via the back wall W, and thus still in this position a listener will experience a stereo image, namely a left-right stereo image. The low frequency mono signal MLF from the woofer WF will be received in all listening positions, since at low frequencies the loudspeaker will be substantially omnidirectional.

In conclusion, almost in any direction, the loudspeaker will generate a stereo image.

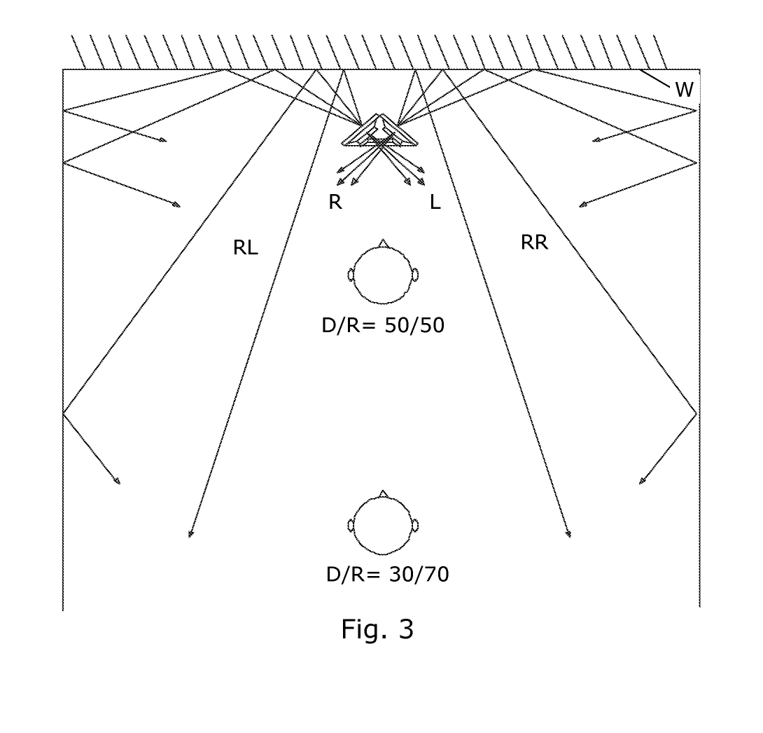

FIG. 3 shows the same loudspeaker embodiment as in FIG. 2 placed this time in a room, still near a back wall W. Again the direct left and right sound L, R from the loudspeaker and the reflected left and right sound RL, RR via the back wall W and side walls are indicated by arrows. Two listener positions are indicated in the room: one rather close to the loudspeaker, and one rather far from the loudspeaker. In both cases the approximate ratios D/R between direct and reflected sound are indicated, namely approximately an equal amount of direct and reflected sound (50% each), and a majority of reflected sound (70% versus 30% direct sound), respectively.

This means that a listener far away from the loudspeaker will experience a stereo image based on the reflected sound, i.e. RL and RR, while a listener rather close to the loudspeaker will experience a stereo image based on the direct sound L, R from the loudspeaker.

In conclusion, at all distances the loudspeaker will generate a stereo image if it is placed in a room since the loudspeaker is designes to utilize reflections from the walls in helping to provide a stereo image where the direct sound from the loudspeaker fails to do so.

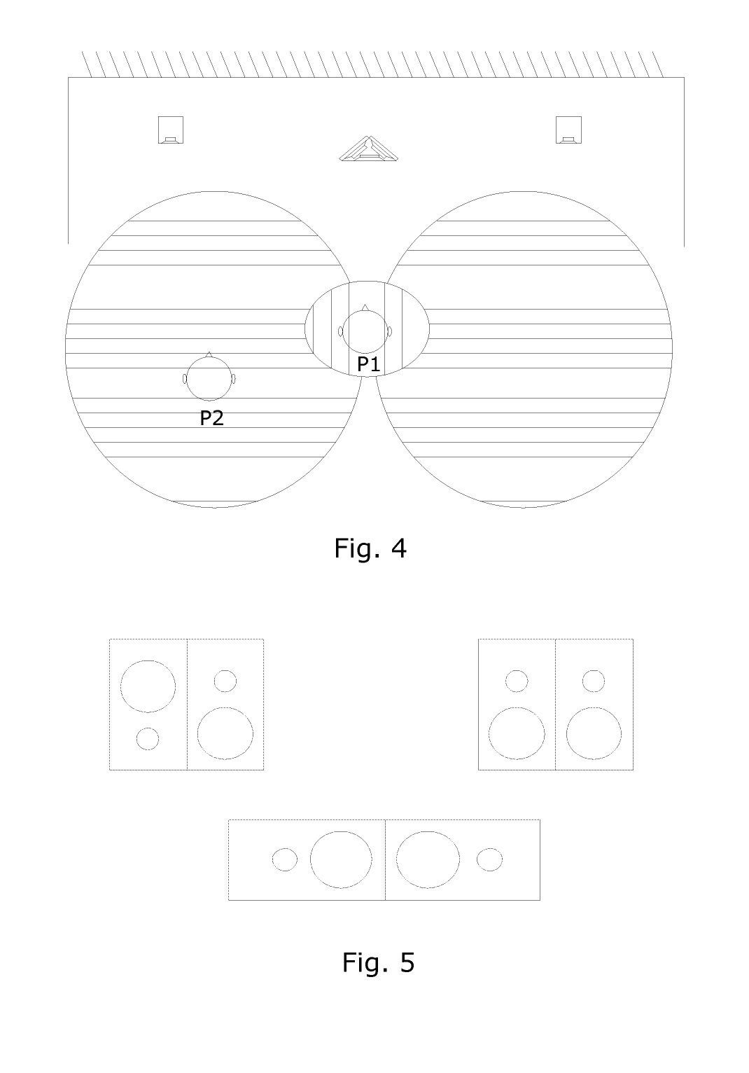

FIG. 4 illustrates a comparison between the stereo image obtained with the loudspeaker according to the invention and a traditional stereo set of loudspeakers when both loudspeaker system are placed in a room. The vertically crossed area indicates the rather small area where the traditional stereo loudspeaker setup provides an optimal stereo image. The horizontally crossed area indicates the large area where the loudspeaker according to the invention will provide an optimal stereo image.

In listener position P1, the listener is within the area where the distance to the two traditional stereo loudspeakers is approximately the same, and thus they will produce a stereo image as intended. However, in listener position P2, the listener is much closer to the left loudspeaker than the right loudspeaker, and therefore arrival time and intensity differences will severely distort the perceived stereo image, and in practice all sound will be heard as coming from the left loudspeaker.

For the loudspeaker according to the invention, the situation is actually opposite, since in position P1, right front of the loudspeaker, reflections from the side walls will tend to produce a rather blurred stereo image together with the direct sound from the loudspeaker, since here both left and right channel sound is received from left side. However, in position P2 one channel is predominantly received as direct sound from the loudspeaker while the other channel is predominantly received reflected from the back or side wall. Thus, in practice, the loudspeaker according to the invention will produce stereo sound in a much larger area than a conventional two-loudspeaker stereo setup, and compared to conventional one-cabinet stereo loudspeaker systems, the difference is even more pronounced.

FIG. 5 illustrates three examples of configuration of dipole loudspeaker units in cases where the loudspeaker comprises two set of dipole loudspeaker units, i.e. one set of at least two loudspeaker units in each side, here illustrated as a set including a tweeter unit (indicated by a small circle) and a mid range unit (indicated by a large circle). The two configurations shown in the upper part of FIG. 5 illustrate examples where the two loudspeaker units in each set are mutually displaced vertically, and in the special example the two units are vertically aligned. The upper configuration to the left shows the tweeter and mid range units being asymmetrical, since to the left the mid range unit is mounted above the tweeter unit, while in the opposide side their vertical order is reversed. Hereby the total width of the loudspeaker can be reduced down to a size smaller than two times the dimension of the largest loudspeaker unit. The embodiment to the right shows a symmetrical configuration where the tweeter is mounted above the mid range driver (could be reversed) in both sides. Both of the upper configurations are suited for rather tall and slim loudspeaker designs.

The lower configuration shows an example where the two loudspeaker units are horizontally aligned in both sides, and where the tweeter units are placed away from the centre of the loudspeaker (could alternatively be the mid range units). The lower configuration is suited for a loudspeaker design with a limited height.

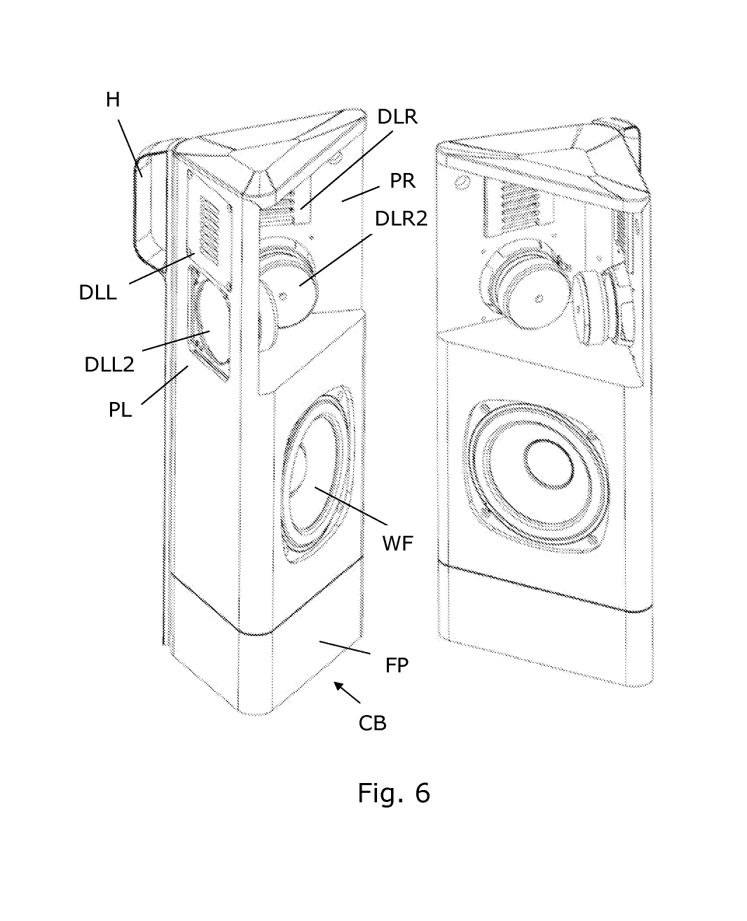

FIG. 6 shows two 3D views of a preferred embodiment with a narrow and tall cabinet CB provided with a handle H, since this embodiment is a portable version and is suited for playing while standing on a table or shelf or the like, most preferably rather close to a wall so as to profit from reflections from the wall, in the manner described above. The shown embodiment has a cabinet CB with a generally triangular shape, where the plane front panel FP is intended to face towards the listener. For normal use, an acoustically transparent fabric covers and thus protects the loudspeaker units DLL, DLL2, DLR, DLR2, WF.

The illustrated embodiment has a two-way dipole loudspeaker unit system, where dipole tweeters DLL, DLR in the form of air motion transformer units reproduce a high frequency part of the input signal, e.g. above 2-5 kHz, while traditional cone based mid range units DLL2, DLR2 having an open structure to ensure a dipole radiation pattern serve to reproduce the frequency range between 200-500 Hz and 2-5 kHz. Both the tweeters DLL, DLR and the mid range units DLL2, DLR2 are mounted in holes in plane panels PL, PR or baffles that constitute the upper part of the cabinet CB, which is an open structure, thus providing acoustically free radiation from both sides of the loudspeaker units' DLL, DLR, DLL2, DLR2 diaphragms. The panels PL, PR or baffles in the shown embodiment are angled 90° in relation to each other, and they are both angled 135° in relation to a front panel FP of the loudspeaker which is intended to be directed towards the listening position during normal use. The lower part of the cabinet CB is formed by a triangularly shaped enclosure with a front panel FP or baffle. A low frequency loudspeaker unit WF or woofer is mounted in a hole in the front panel FP and thus its diaphragm extends in a plane perpendicular to a preferred direction towards the listening position during normal use. The woofer WF operates below 2-500 Hz and is preferably applied with a mono signal being a combined version of the left and right stereo input signals.

Preferably, the loudspeaker is active, i.e. includes power amplifiers for driving the loudspeaker units. The loudspeaker may be provided with a wireless Radio Frequency interface that allows wireless streaming of audio signals without cabling. Preferably, the loudspeaker is provided with a conversion facility allowing the loudspeaker to switch from the described stereo configuration to a mono configuration, i.e. where the dipole loudspeakers in both sides play the same signal. Hereby the loudspeaker can be used to play one stereo channel, while another similar loudspeaker can be used to play the other stereo channel, thus allowing a user to upgrade from one stereo loudspeaker to a more powerful two loudspeaker system. Another use of the stereo capabilities of the loudspeaker is as a one-cabinet back loudspeaker forming part of a surround sound setup.

The power supply may be by means of batteries or by means of a high voltage (e.g. 230 V) AC power socket or by means of a low voltage socket suited for connection to an external power supply.

To sum up, the invention provides a stereo loudspeaker in a single cabinet CB, such as a portable stereo loudspeaker. Two dipole loudspeaker units DLL, DLR generate respective acoustic dipole signals L+, L−, R+, R− in accordance with two channels on an input signal. The two dipole loudspeaker units DLR, DLL are closesly spaced and oriented such in relation to each other that their respective main axes are angled α 70°-110°, such as 80°-100°, preferably substantially 90°, relative to each other. By placing such stereo loudspeaker in a room in front of a wall W, reflections RL, RR from one side of the two dipole units' DLL, DLR diaphragms will reach a listener and thus serve to provide, together with the direct sound L, R from the opposite side of the diaphragms, a stereo image in a wide area in the room. The dual dipole arrangement enables a one-cabinet stereo loudspeaker with a narrow design. The dipole arrangement may be a two-way system with dipole tweeter units and dipole mid range units. A mono low frequency unit WF may be included in the cabinet CB. The stereo loudspeaker can be configurable to either play stereo or to play mono, i.e. the dipole units DLL, DLR playing the same signals. Hereby the loudspeaker can play one channel while a similar loudspeaker plays another channel, thus allowing such set of loudspeakers to be used in a traditional stereo setup.

Although the present invention has been described in connection with preferred embodiments, it is not intended to be limited to the specific form set forth herein. Rather, the scope of the present invention is limited only by the accompanying claims.

In this section, certain specific details of the disclosed embodiments are set forth for purposes of explanation rather than limitation, so as to provide a clear and thorough understanding of the present invention. However, it should be understood readily by those skilled in this art, that the present invention may be practised in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Reference signs are included in the claims however the inclusion of the reference signs is only for clarity reasons and should not be construed as limiting the scope of the claims.

1. A loudspeaker arranged to receive an input signal with first and second channels and to generate respective first and second acoustic signals accordingly, the loudspeaker having a cabinet (CB) comprising:
a set of first and second dipole loudspeaker units (DLL, DLR) arranged to receive respective left and right channel signals and to generate respective first (L+, L−) and second (R+, R−) acoustic dipole signals accordingly,
wherein the first and second dipole loudspeaker units (DLL, DLR) are closely spaced and oriented in relation to each other such that their respective main axes are angled (α) 70°-110°, relative to each other, wherein the first and second dipole loudspeaker units (DLL, DLR) are placed in the same horizontal plane, and
wherein both of the first and second dipole loudspeaker units (DLL, DLR) are mounted in the cabinet (CB) so as to freely radiate their respective acoustic dipole signals (L+, L−, R+, R−) away from the loudspeaker.

2-19. (canceled)

20. The loudspeaker according to claim 1, wherein one side of the diaphragms of the first and second dipole loudspeaker units (DLL, DLR) are arranged to generate direct sound (L, R) to a listener, and the opposite side of the diaphragms of the first and second dipole loudspeaker units (DLL, DLR) are arranged to generate sound to the listener (RL, RR) via reflecting surfaces, such as walls.

21. The loudspeaker according to claim 1, wherein the first and second dipole loudspeaker units (DLL, DLR) are oriented in relation to each other such that their respective main axes are substantially perpendicular to each other.

22. The loudspeaker according to claim 1, wherein the first and second dipole loudspeaker units (DLL, DLR) are oriented in the cabinet (CB) with fronts of their diaphragms pointing away from a front (FP) of the cabinet (CB).

23. The loudspeaker according to claim 1, wherein the cabinet (CB) has a generally triangular top view with substantially plane cabinet front (FP).

24. The loudspeaker according to claim 1, wherein the first and second dipole loudspeaker units (DLL, DLR) are spaced with a distance between centres of their diaphragms being smaller than two times a maximum extension of their diaphragms.

25. The loudspeaker according to claim 1, comprising a second set of first and second dipole loudspeaker units (DLL2, DLR2) arranged to generate respective third and fourth signals accordingly, wherein the second set of dipole loudspeaker units (DLL2, DLR2) are oriented in relation to each other such that their respective main axes are angled 70°-110°, relative to each other.

26. The loudspeaker according to claim 25, wherein the second set of dipole loudspeaker units are positioned in substantially the same horizontal plane as the first set of dipole loudspeaker units.

27. The loudspeaker according to claim 25, wherein the second set of dipole loudspeaker units (DLL2, DLR2) are vertically displaced relative to the first set of dipole loudspeaker units (DLL, DLR).

28. The loudspeaker according to claim 25, comprising a dividing network, arranged to split the input signal into a higher frequency band, which is applied to the first set of dipole loudspeaker units (DLL, DLR) and into a lower frequency band, which is applied to the second set of dipole loudspeaker units (DLL2, DLR2).

29. The loudspeaker device according to claim 1, comprising a loudspeaker unit (WF) arranged to generate an acoustic signal below a lower cut-off frequency of the input signal.

30. The loudspeaker according to claim 1, arranged to receive the input signal in a digital format.

31. The loudspeaker according to claim 1, comprising amplifiers arranged to amplify the input signal and to apply the respective amplified signals to the first and second dipole loudspeaker units (DLL, DLR).

32. The loudspeaker according to claim 1, comprising a configuration means arranged to apply substantially the same electric signal to both of the first and second dipole loudspeaker units (DLL, DLR).

33. A method for playing an input signal with first and second channels, the method comprising:
receiving the input signal, and
applying electrical signals corresponding to left and right channels to respective first and second dipole loudspeaker units arranged to generate respective first and second acoustic dipole signals accordingly,
wherein the first and second dipole loudspeaker units are mounted closely spaced in a cabinet are oriented such in relation to each other that their respective main axes are angled 70°-110° relative to each other, wherein the first and second dipole loudspeaker units (DLL, DLR) are arranged in the cabinet (CB) with their main axes substantially being in a horizontal plane, and
wherein both of the first and second dipole loudspeaker units (DLL, DLR) are mounted in the cabinet (CB) so as to freely radiate their respective acoustic dipole signals (L+, L−, R+, R−) away from the loudspeaker.
